(19) United States
(12) Patent Application Publication
(10) Pub. No.: US 2026/0370093 A1
(43) Pub. Date: Nov. 19, 2026

(54) ELECTRIC DRIVE UNIT HAVING A FLUID SUMP

(71) Applicant: BorgWarner Inc., Auburn Hills, MI (US)

(72) Inventors: Christopher Anthony Chirco, Romeo, MI (US); Aniruddha Chavan, Rochester Hills, MI (US); Qingyuan Zha, Novi, MI (US); Dileep Kumar Rangapura Shivakumara, Karnataka (IN)

(21) Appl. No.: 19/671,353

(22) Filed: May 8, 2026

Related U.S. Application Data
(60) Provisional application No. 63/882,518, filed on Sep. 16, 2025.
(60) Provisional application No. 63/806,435, filed on May 15, 2025.

(51) Int. Cl. H02K 9/193; H02K 5/20; H02K 7/116; H02K 9/26; H02K 17/16

(52) U.S. Cl. CPC H02K 9/193; H02K 5/203; H02K 7/116; H02K 9/26; H02K 17/168; H02K 2205/09

(57) ABSTRACT

An electric drive unit includes a housing assembly including a main housing body extending along a first axis. The main housing body defines a housing interior and includes a divider wall that subdivides the housing interior into a first and second chambers. An electric machine is disposed in the first chamber. A differential assembly is disposed in the second chamber. A reduction gearset is coupled to the electric machine and the differential assembly. The main housing body further defines a fluid sump spaced radially outward relative to the first axis from the first chamber and the second chamber, a first drain path extending between the first chamber and the fluid sump for returning the fluid from the first chamber to the fluid sump, and a second drain path extending between the second chamber and the fluid sump for returning the fluid from the second chamber to the fluid sump.

### CROSS-REFERENCE TO RELATED APPLICATIONS

The present application claims priority to and all the benefits of U.S. Provisional Patent Application Nos. 63/806,435 filed on May 15, 2025, and 63/882,518 filed September 16, 2025, which are hereby expressly incorporated herein by reference in their entirety.

### BACKGROUND OF THE INVENTION

### Field of the Invention

The present disclosure relates generally to an electric drive unit having a fluid sump.

### Description of Related Art

Electric drive units often package rotating components, such as an electric machine, a reduction gearset, and a differential assembly, within a housing interior of a housing assembly. The housing assembly is often required to support these rotating components while also managing storage and recirculation of lubricating and/or cooling fluid through the housing interior. In compact electric drive units, there are challenges in designing effective fluid-supply and fluid-return paths due to packaging constraints (e.g. due to the limited envelope provided for disposing the electric drive unit within the vehicle and/or due to the installation orientation of the electric drive unit relative to the vehicle). Furthermore, in typical electric drive unit configurations, fluid often pools in the housing interior, leading to churning losses when the rotating componentry agitates the fluid pooled within the housing interior. Accordingly, there remains a need for an improved electric drive unit having a fluid sump.

### SUMMARY AND ADVANTAGES

The present disclosure is generally directed to an electric drive unit including a housing assembly. The housing assembly includes a main housing body extending along a first axis between a first end and a second end spaced from the first end in a first direction along the first axis. The main housing body defines a housing interior about the first axis and includes a divider wall that subdivides the housing interior into a first chamber extending along the first axis and delimited by the divider wall in the first direction, and a second chamber extending along the first axis delimited by the divider wall in a second direction opposite the first direction. The electric drive unit also includes an electric machine disposed in the first chamber and a differential assembly disposed in the second chamber. The electric drive unit further includes a reduction gearset coupled to the electric machine and the differential assembly for transmitting torque between the electric machine and the differential assembly. The main housing body further defines a fluid sump spaced radially outward relative to the first axis from the first chamber and the second chamber, a first drain path extending between the first chamber and the fluid sump to arrange the first chamber in fluid communication with the fluid sump for returning fluid from the first chamber to the fluid sump, and a second drain path extending between the second chamber and the fluid sump to arrange the second chamber in fluid communication with the fluid sump for returning the fluid from the second chamber to the fluid sump.

Advantageously, fluid from the first chamber and the second chamber is directed to and collected in the fluid sump through the first and second drain paths for recirculation through the housing interior. More specifically, by virtue of the fluid sump being spaced radially outward relative to the first axis from the first chamber and the second chamber, fluid returning from the first and second chambers to the fluid sump is drawn away from the rotating componentry disposed in the first and second chambers, thereby reducing churning losses that would otherwise result when such rotating componentry agitates fluid pooled within the housing interior.

### BRIEF DESCRIPTION OF THE DRAWINGS

Other advantages of the present disclosure will be readily appreciated, as the same becomes better understood by reference to the following detailed description when considered in connection with the accompanying drawings.

FIG. 1 is a perspective view of the electric drive unit according to the present disclosure.

FIG. 2A is an exploded view of the electric drive unit of FIG. 1 from a first perspective.

FIG. 2B is another exploded view of the electric drive unit of FIG. 1 from a second perspective.

FIG. 3 is a side view of the electric drive unit.

FIG. 4 is a cross-sectional representation of the electric drive unit taken through line 4-4 of FIG. 3.

FIG. 5 is a detail view of FIG. 4 illustrating a fluid sump of the electric drive unit.

FIG. 6 is a partial perspective cross-sectional representation of the electric drive unit illustrating the fluid sump.

FIG. 7 is a partial cross-sectional representation of the electric drive unit illustrating a path between the fluid sump and a fluid pump.

FIG. 8 is a perspective view of the electric drive unit illustrating a feeding path and a main supply channel in phantom.

FIG. 9 is a cross-sectional representation taken along line 9-9 of FIG. 4 to reveal the componentry of a differential assembly of the electric drive unit.

FIG. 10 is a cross-sectional representation taken along line 10-10 of FIG. 4 to reveal the componentry of a second planetary gearset of the reduction gearset of the electric drive unit.

FIG. 11 is a cross-sectional representation taken along line 11-11 of FIG. 4 to reveal the componentry of a first planetary gearset of the reduction gearset of the electric drive unit.

FIG. 12 is a cross-sectional representation taken along line 12-12 of FIG. 4 to reveal the componentry of an electric machine of the electric drive unit.

FIG. 13 is a cross-sectional representation taken along line 13-13 of FIG. 3 to reveal a main supply line and a plurality of distribution channels of the electric drive unit.

### DETAILED DESCRIPTION OF THE INVENTION

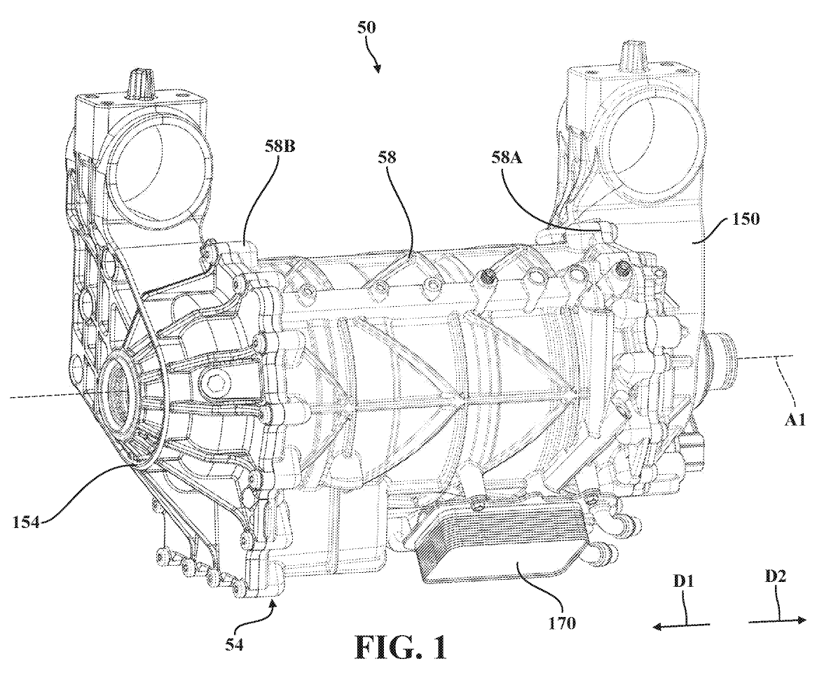

Referring to the drawings, wherein like reference numerals are used to identify like or identical components in the various views, FIGS. 1‑13 illustrate an electric drive unit 50 according to the present disclosure. The electric drive unit 50 according to the present disclosure is generally configured for use in an electrified vehicle for providing propulsion torque and/or for receiving regenerative braking torque. While the electric drive unit 50 according to the present disclosure is described in the context of automotive applications, other vehicle applications employing the electric drive unit 50 are also contemplated including, but not limited to, heavy duty trucks, agricultural vehicles, construction vehicles, and recreational vehicles.

Referring to FIG. 1, the electric drive unit 50 includes a housing assembly 54. The housing assembly 54 includes a main housing body 58 extending along a first axis A1 between a first end 58A and a second end 58B spaced from the first end 58A in a first direction D1 along the first axis A1. The main housing body 58 defines a housing interior 62 about the first axis A1 within which the internal componentry of the electric drive unit 50 is disposed, as described in further detail below. The main housing body 58 includes a divider wall 66 that subdivides the housing interior 62 into a first chamber 70 and a second chamber 74 extending along the first axis A1. The first chamber 70 is delimited by the divider wall 66 in the first direction D1. The second chamber 74 is delimited by the divider wall 66 in a second direction D2 opposite the first direction D1. The electric drive unit 50 further includes various components which rotate in the housing interior 62 including an electric machine 78 disposed in the first chamber 70, a differential assembly 82 disposed in the second chamber 74, and a reduction gearset 86 coupled to the electric machine 78 and the differential assembly 82 for transmitting torque between the electric machine 78 and said differential assembly 82. Exemplary configurations of the electric machine 78, the differential assembly 82, and the reduction gearset 86 are shown throughout the FIGS. and described in further detail below.

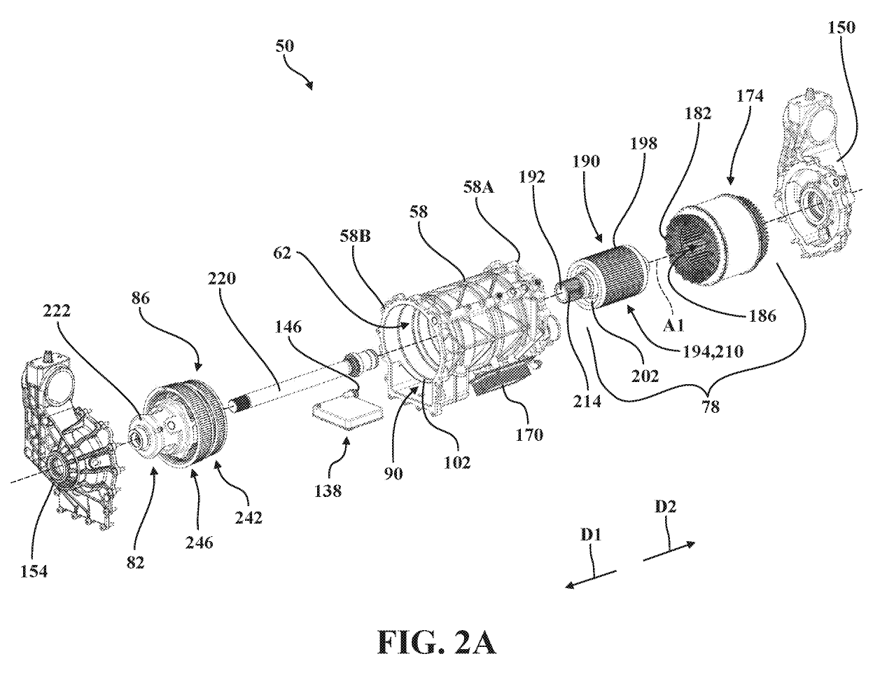

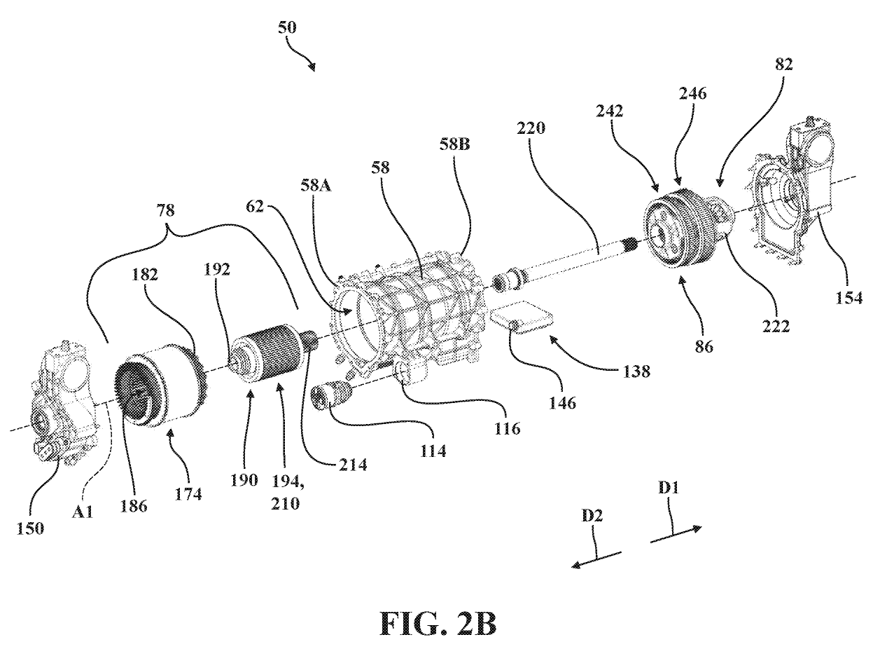

As best shown in FIGS. 2A and 4-6, the main housing body 58 further defines a fluid sump 90 spaced radially outward relative to the first axis A1 from the first chamber 70 and the second chamber 74. The fluid sump 90 generally serves as a reservoir, also commonly referred to as a basin, for collecting fluid from the housing interior 62 for recirculation through the housing interior 62 (e.g. via a pump 114, as described in further detail below). The fluid may be any cooling and/or lubrication fluid suitable for the application, such as oil.

The main housing body 58 also defines a first drain path 94 extending between the first chamber 70 and the fluid sump 90 to arrange the first chamber 70 in fluid communication with the fluid sump 90 for returning the fluid from the first chamber 70 to the fluid sump 90. The main housing body 58 additionally defines a second drain path 98 extending between the second chamber 74 and the fluid sump 90 to arrange the second chamber 74 in fluid communication with the fluid sump 90 for returning the fluid from the second chamber 74 to the fluid sump 90. Accordingly, the fluid from the first chamber 70 and the second chamber 74 is directed to and collected in the fluid sump 90 through the first and second drain paths 94, 98, respectively, for recirculation through the housing interior 62. In this regard, the fluid sump 90 is a shared reservoir for collecting the fluid from both the first chamber 70 and the second chamber 74 for recirculation through the housing interior 62.

In typical vehicle installations, the electric drive unit 50 is configured to be installed in a vehicle at a predetermined orientation such that the fluid sump 90 is arranged below the first chamber 70 and the second chamber 74 under typical pitch/roll conditions of the vehicle by virtue of the fluid sump 90 being spaced radially outward relative to the first axis A1 from the first chamber 70 and the second chamber 74. Thus, due to gravity, the fluid from the first chamber 70 and the second chamber 74 is drawn away from the rotating componentry disposed in the first and second chambers 70, 74 and directed to the fluid sump 90, thereby reducing churning losses that would otherwise result when such rotating componentry agitates fluid pooled within the first and second chambers 70, 74.

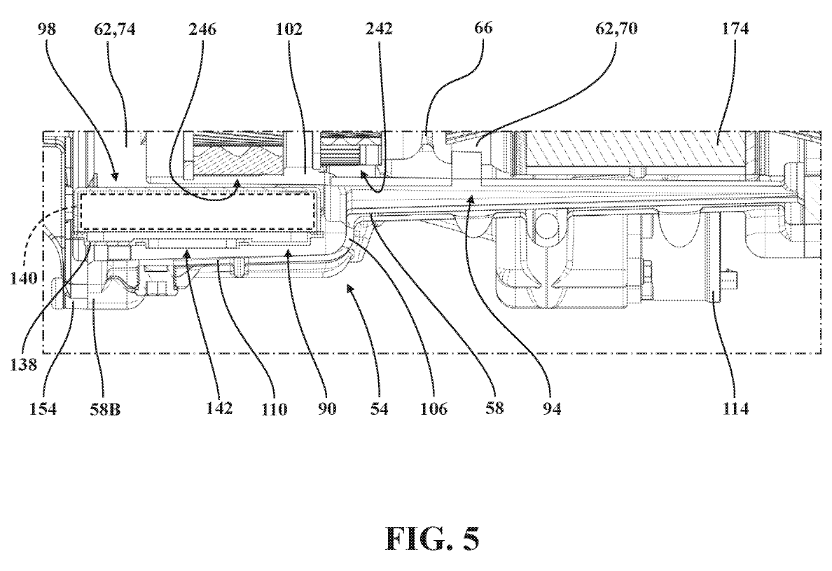

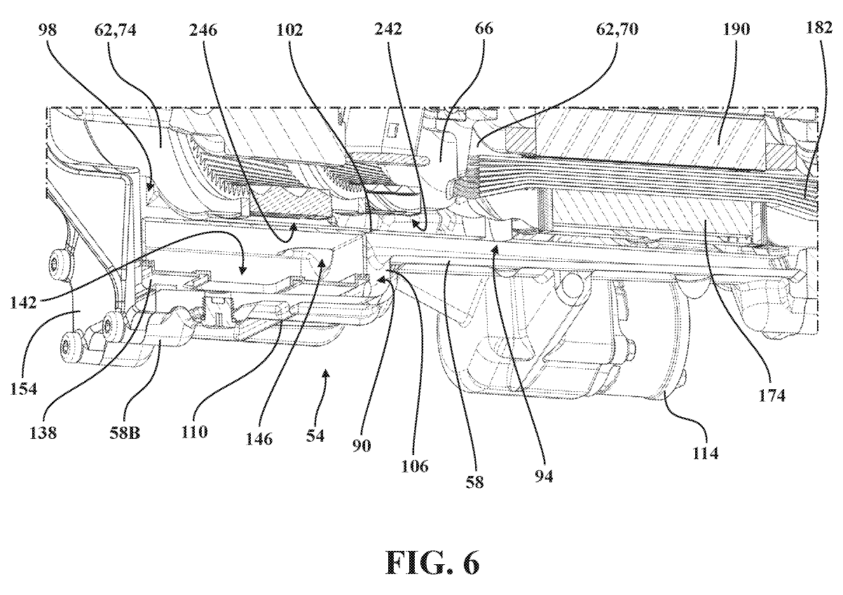

As best shown in FIGS. 5 and 6, in the illustrated configuration, to further reduce churning losses, the main housing body 58 may further include an upper sump wall 102 extending axially relative to the first axis A1 to at least partially separate the fluid sump 90 from the first chamber 70 and the second chamber 74. Stated differently, the upper sump wall 102 is configured to at least partially isolate the fluid sump 90 from first and second chambers 70, 74 of the housing interior 62 while the second chambers 70, 74 remain in fluid communication with first and second chambers 70, 74 through the respective first and second drain paths 94, 98. In the illustrated configuration, the first drain path 94 extends through the upper sump wall 102 between first chamber 70 and the fluid sump 90 to arrange the first chamber 70 in fluid communication with the fluid sump 90, and the second drain path 98 extends through the upper sump wall 102 between second chamber 74 and the fluid sump 90 to arrange the second chamber 74 in fluid communication with the fluid sump 90. With continued reference to FIGS. 5 and 6, the main housing body 58 also typically includes a radial extension 106 and a lower sump wall 110 which further define/delimit the fluid sump 90. However, other configurations for defining the fluid sump 90 are contemplated.

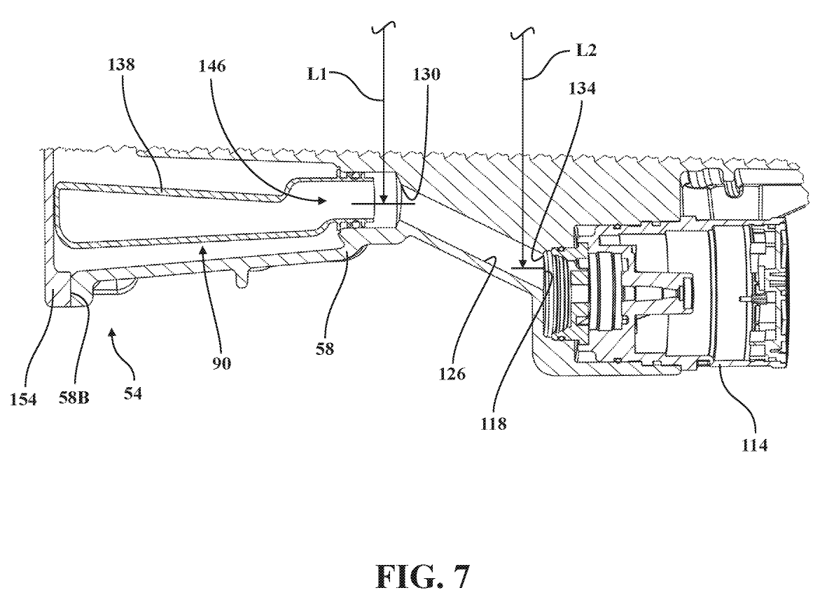

Referring to FIGS. 2B and 4-7, the electric drive unit 50 typically further includes a fluid pump 114 coupled to the main housing body 58 and configured to direct the fluid from the fluid sump 90 to the housing interior 62. In the illustrated configuration, referring to FIG. 2B, the main housing body 58 defines a pump receptacle 116 configured to at least partially receive the fluid pump 114 to couple the fluid pump 114 to the main housing body 58 and arrange the fluid pump 114 in fluid communication with the fluid sump 90 and the housing interior 62. Other configurations of coupling the fluid pump 114 to the main housing body 58 are contemplated without departing from the scope of the present disclosure. As best shown in FIG. 7, the fluid pump 114 defines a pump inlet 118 in fluid communication with the fluid sump 90 and a pump outlet 122 in fluid communication with the housing interior 62. With continued reference to FIG. 7, to arrange the pump inlet 118 in fluid communication with the fluid sump 90, the main housing body 58 may also define a fluid passage 126 extending between a fluid passage inlet 130 in fluid communication with the fluid sump 90 in fluid communication with the pump inlet 118. Although not required, as best shown in FIG. 7, the fluid passage inlet 130 may be radially spaced from the first axis A1 at a first distance L1, and the fluid passage outlet 134 may be radially spaced from the first axis A1 at a second distance L2 greater than the first distance L1. Accordingly, when the electric drive unit 50 is installed in a vehicle at the typical predetermined orientation described above, the fluid passage outlet 134 is below the fluid passage inlet 130 such that fluid pools within the fluid passage 126 toward the fluid passage outlet 134 to prime the fluid pump 114 and allow air to escape upwardly through the fluid passage 126, thereby improving the performance and longevity of the fluid pump 114.

As best shown in FIGS. 5-7, although not required, the electric drive unit 50 may further include an integrated fluid filter housing 138 disposed in the fluid sump 90. In other words, in the illustrated configuration, the fluid filter housing 138 is disposed internal to the fluid sump 90 and not disposed outside of the fluid sump 90. The integrated fluid filter housing 138 is configured to receive a filter 140 (illustrated schematically in FIG. 5) for filtering contaminants as the fluid travels from the fluid sump 90 toward the fluid pump 114. As best shown in FIGS. 6 and 7, the integrated fluid filter housing 138 defines a filter housing inlet 142 in fluid communication with the fluid sump 90 and a filter housing outlet 146 in fluid communication with the fluid passage inlet 130. Accordingly, in the illustrated configuration, in response to operation of the fluid pump 114, the fluid flows from the fluid sump 90 into the filter housing inlet 142, from the filter housing inlet 142 through the filter 140 disposed in the integrated fluid filter housing 138 to the filter housing outlet 146, from the filter housing outlet 146 to the fluid passage inlet 130, and through the fluid passage 126 to the fluid passage outlet 134 to the fluid pump 114 for recirculation to the housing interior 62. Other arrangements of a fluid filter housing 138 are contemplated without departing from the scope of the present disclosure.

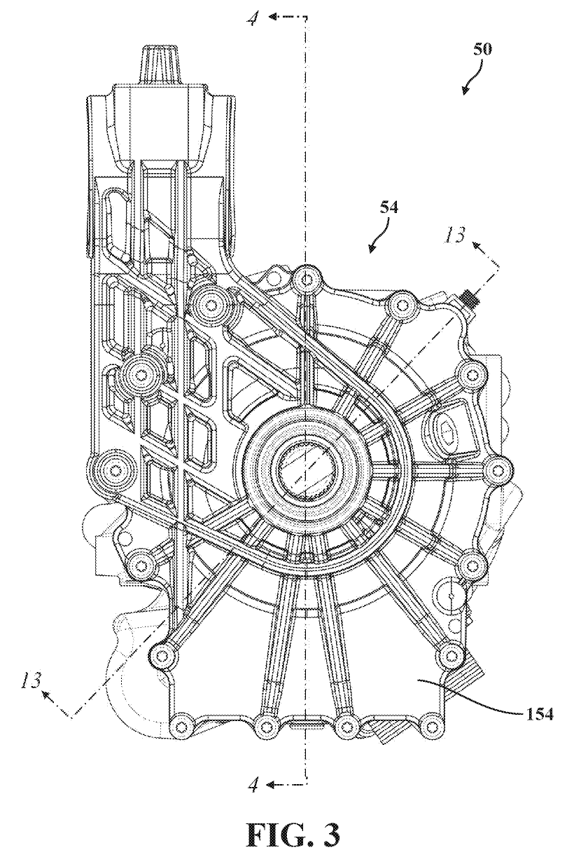

As shown throughout FIGS. 1-8, the housing assembly 54 typically further includes a first end cover 150 coupled to the first end 58A of the main housing body 58 to delimit the first chamber 70 in the second direction D2. In the illustrated configuration, the first end cover 150 is formed as a separate component that is removably coupled to the first end 58A of the main housing body 58; however, other configurations where the first end cover 150 is formed integrally or is otherwise permanently coupled with the first end 58A of the main housing body 58 (i.e., the first end cover 150 is not removable relative to the first end 58A of the main housing body 58) are contemplated. With continued reference to FIGS. 1-8, the housing assembly 54 typically further includes a second end cover 154 coupled to the second end 58B of the main housing body 58 to delimit the second chamber 74 in the first direction D1. In the illustrated configuration, the second end cover 154 is formed as a separate component that is removably coupled to the second end 58B of the main housing body 58; however, other configurations where the second end cover 154 is formed integrally or is otherwise permanently coupled with the second end 58B of the main housing body 58 (i.e., the second end cover 154 is not removable relative to the second end 58B of the main housing body 58) are contemplated. In some configurations, as best shown in FIGS. 5 and 6, the second end cover 154 may also delimit the fluid sump 90 in the first direction D1. In these configurations, the second end cover 154 is typically removably coupled to the main housing body 58 so that the integrated fluid filter housing 138 and the filter 140 are accessible from the second end 58B for service, inspection, or replacement. Here, the second end cover 154 may also abut the integrated fluid filter housing 138 to maintain the integrated fluid filter housing 138 in its desired position. Other configurations for securing the integrated fluid filter housing 138 within the fluid sump 90 are contemplated.

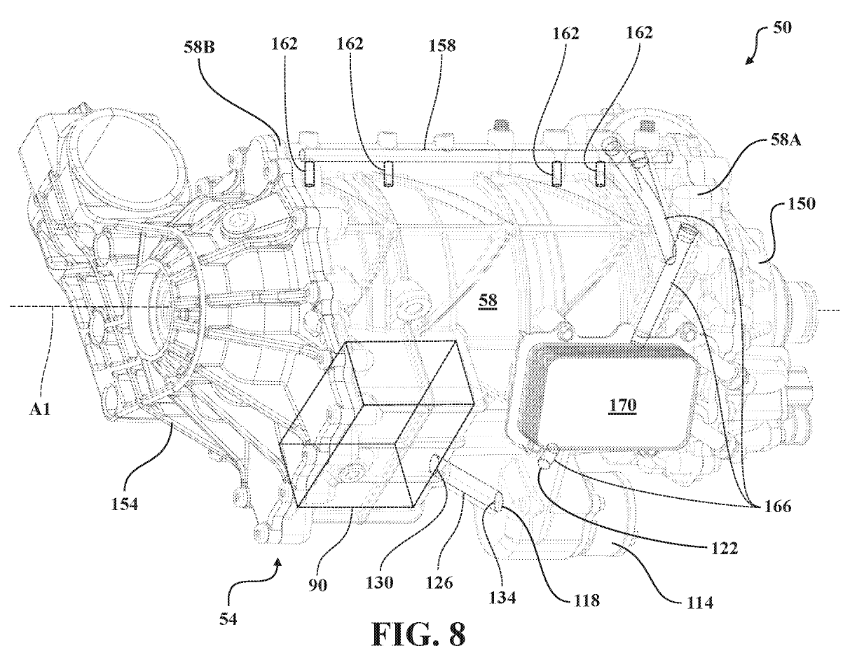

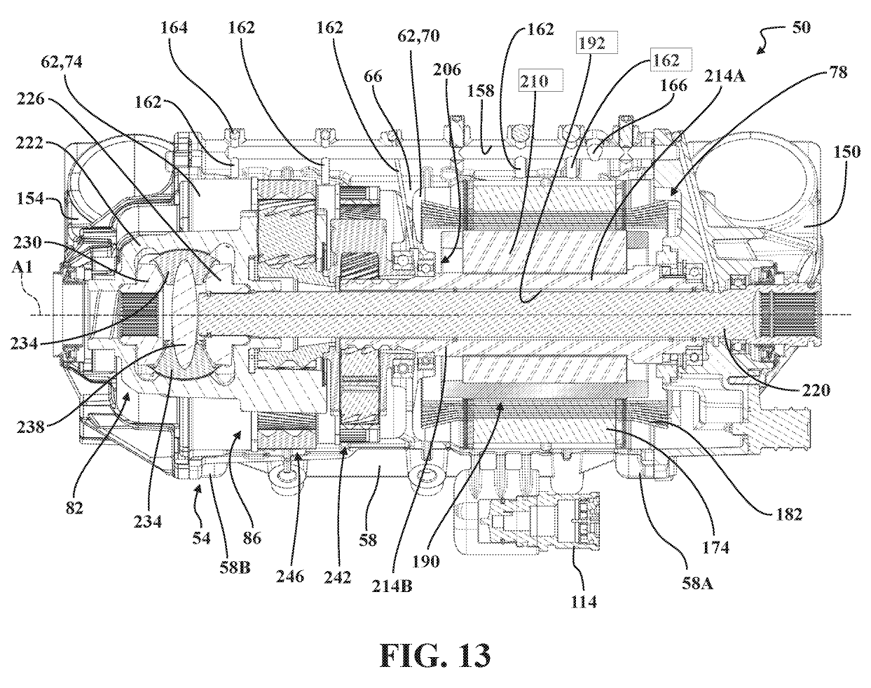

As best shown in FIGS. 8 and 13, to recirculate the fluid from the fluid sump 90 and fluid pump 114 back to the housing interior 62, the main housing body 58 may further define a main supply channel 158, a plurality of distribution channels 162, and a fluid feeding path 166. As best shown in FIG. 13, in the illustrated configuration, the main supply channel 158 is spaced radially from the first axis A1 and extends parallel to the first axis A1. In the illustrated configuration, as best shown in FIG. 13, the main supply channel 158 is arranged radially outward from the first and second chambers 70,74. Here, the plurality of distribution channels 162 extend between the main supply channel 158 and at least one of the first and second chambers 70,74 to arrange the main supply channel 158 in fluid communication with at least one of the first chamber 70 and the second chamber 74 for directing the fluid from the main supply channel 158 into the at least one of the first chamber 70 and said second chamber 74. Other configurations of the main supply channel 158 and the plurality of distribution channels 162 are contemplated without departing from the scope of the present disclosure.

As best shown in FIG. 8, the fluid feeding path 166 is in fluid communication with the pump outlet 122 and the main supply channel 158 for directing the fluid from the pump outlet 122 to the main supply channel 158. Thus, cumulatively, the fluid feeding path 166 arranges the pump outlet 122 in fluid communication with the main supply channel 158, and the plurality of distribution channels 162 arrange the main supply channel 158 in fluid communication with at least one of the first chamber 70 and the second chamber 74 to recirculate the fluid from the fluid sump 90 to the housing interior 62. With continued reference to FIG. 8, in some examples, the electric drive unit 50 further includes a heat exchanger 170 disposed in fluid communication along the fluid feeding path 166 so that the fluid driven from the fluid pump 114 can be conditioned (i.e., either cooled or heated) before being redistributed into the housing interior 62 through the main supply channel 158 and the distribution channels 162. Other configurations for recirculating the fluid from the fluid sump 90 and fluid pump 114 back to the housing interior 62 are contemplated.

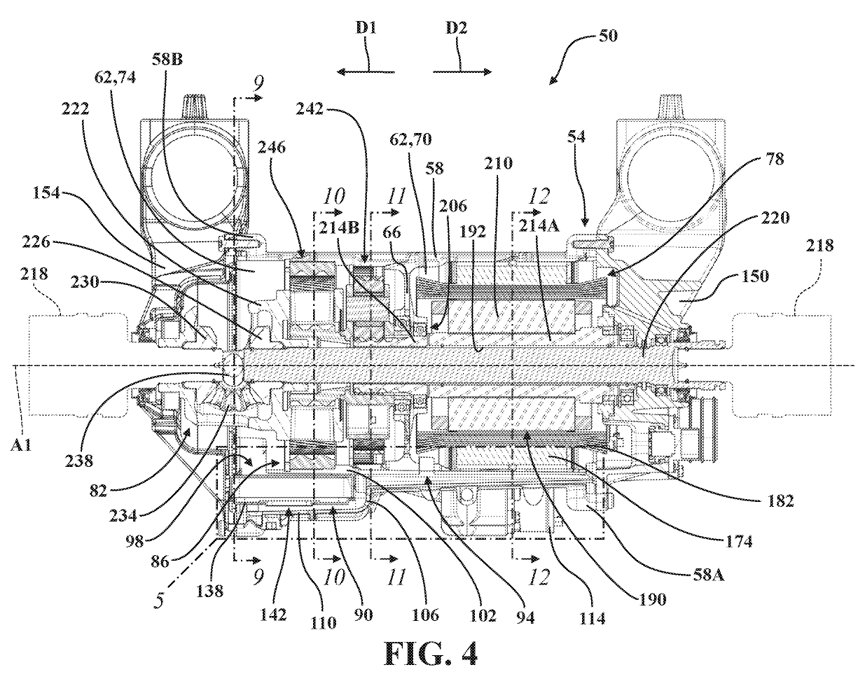

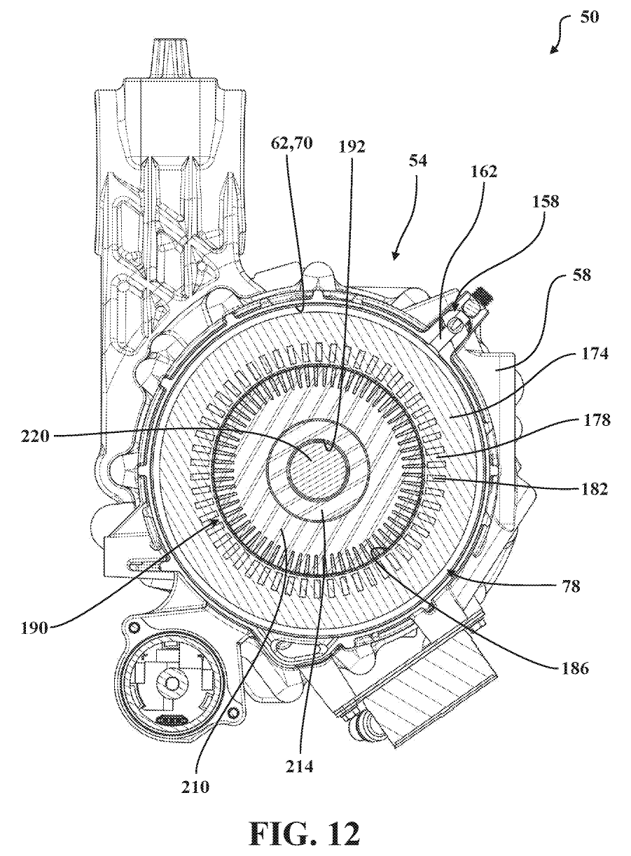

As described above, the electric drive unit 50 includes an electric machine 78. The electric machine 78 is generally configured to generate torque for transfer through the reduction gearset 86 and the differential assembly 82 to propel the vehicle, and may further be configured to receive torque such that the electric machine 78 operates as a generator to regeneratively brake the vehicle. The configuration of the electric machine 78 is not limited for the purposes of this disclosure. Exemplary configurations of the electric machine 78 include permanent magnet synchronous motors, wound-field synchronous motors, switched reluctance motors, synchronous reluctance motors, brushless DC motors, and asynchronous induction motors. As best shown in FIGS. 4 and 12, which represent an asynchronous induction motor configuration, the electric machine 78 includes a stator 174 coupled to the main housing body 58 and disposed annularly about the first axis A1. While the configuration of the stator 174 is not necessarily limited for the purposes of this disclosure, in the illustrated configuration, the stator 174 includes a stator body 176 comprising a plurality of metallic sheets that are laminated together. The stator body 176 may define stator teeth 178 extending radially inward toward the first axis A1. Stator windings 182 may be disposed between the stator teeth 178. In one implementation, the stator windings 182 can be hairpin stator windings; however, other types of stator windings 182 are contemplated. The stator windings 182 can be coupled to a vehicle battery via an inverter and other power electronics that selectively invert the direct current (DC) electrical power stored in the vehicle battery into alternating current (AC) electrical current, and supply the AC electrical current to the stator windings 182 to energize the stator windings 182.

With continued reference to FIGS. 4 and 12, in the illustrated configuration, the stator 174 defines a stator bore 186, and the electric machine 78 further includes a rotor 190 disposed in the stator bore 186 for rotation relative to the stator 174 about the first axis A1 in response to energization of the stator 174 (e.g. in response to energization of the stator windings 182). While the configuration of the rotor 190 is not necessarily limited for the purposes of this disclosure, in the illustrated asynchronous induction motor configuration, the rotor 190 includes a rotor cage 194 having a plurality of metal bars 198 spaced circumferentially about the first axis A1, and a plurality of metallic sheets 202 laminated together and coupled to the plurality of metal bars 198 to cumulatively constitute the rotor 190. Accordingly, in response to energization of the stator windings 182, a magnetic field generated by the stator 174 electromagnetically interacts with the rotor 190 to produce torque on the rotor 190 to rotate the rotor 190 about the first axis A1.

With continued reference to FIG. 4, in the illustrated configuration, the reduction gearset 86 is disposed in the second chamber 74; however, it should be appreciated that in other configurations the reduction gearset 86 may be disposed in the first chamber 70. In configurations where the reduction gearset 86 is disposed in the second chamber 74, the divider wall 66 may define a central void 206 extending along the first axis A1 between the first chamber 70 and the second chamber 74. In these configurations, the rotor 190 may include a rotor body 210 disposed in the stator bore 186 and a rotor shaft 214 extending along the first axis A1. Here, the rotor shaft 214 includes a first rotor shaft portion 214A coupled to the rotor body 210 such that the rotor shaft 214 rotates with the rotor body 210 about the first axis A1 in response to energization of the stator 174, and a second rotor shaft portion 214B extending from the first rotor shaft portion 214A in the first direction D1 through the central void 206 of the divider wall 66. As best shown in FIG. 4, the second rotor shaft portion 214B is coupled to the reduction gearset 86 to transmit torque between the electric machine 78 and the reduction gearset 86. Other configurations of coupling the rotor 190 of the electric machine 78 to the reduction gearset 86 are contemplated.

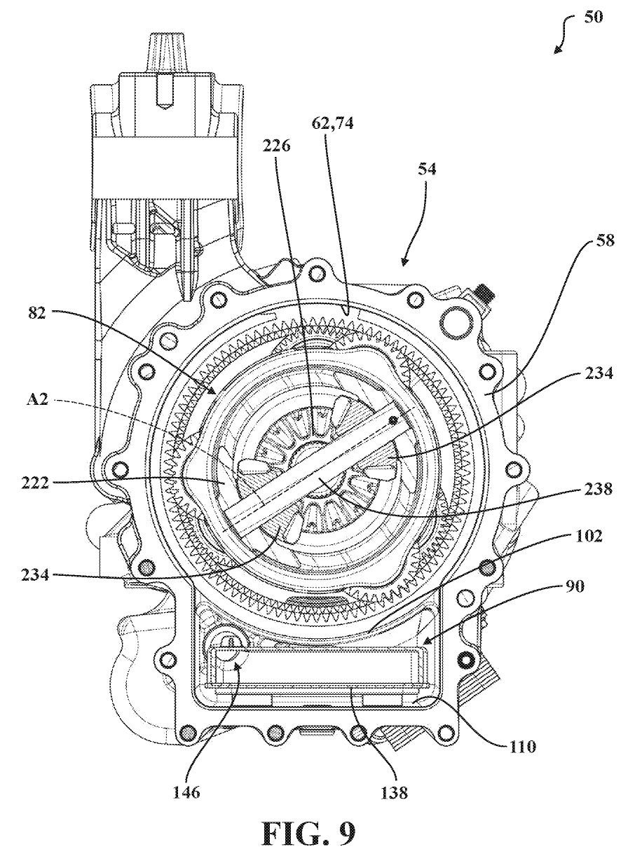

As also described above, the electric drive unit 50 includes a differential assembly 82. The differential assembly 82 is generally configured to receive torque generated by the electric machine 78 (and provided to the differential assembly 82 via the reduction gearset 86) and to transmit that torque to respective half shafts 218 (shown in FIG. 4) while accommodating differential rotation of the half shafts 218 relative to one another. The configuration of the differential assembly 82 is not limited for the purposes of this disclosure. As best shown in FIGS. 4 and 9, in the illustrated configuration, the differential assembly 82 includes a pinion carrier 222 supported for rotation about the first axis A1. The illustrated differential assembly 82 also includes a first side gear 226 disposed in the pinion carrier 222 for rotation relative to the pinion carrier 222 about the first axis A1. The first side gear 226 is configured to be coupled (directly or indirectly through an intermediate component) to one of the half shafts 218. As best shown in FIG. 4, in some embodiments, the electric drive unit 50 further includes a link shaft 220 coupled to the first side gear 226. The link shaft 220 serves as an intermediate component for coupling the first side gear 226 to one of the half shafts 218. In these configurations, the rotor 190 may define a central bore 192 extending along the first axis A1, and the link shaft 220 typically extends from the first side gear 226 in the second direction D2 through the central bore 192 of the rotor 190. Here, the end of the link shaft 220 opposite the first side gear 226 is configured to be coupled to one of the half shafts 218. Other configurations for coupling the first side gear 226 to one of the half shafts 218 are contemplated.

The illustrated differential assembly 82 further includes a second side gear 230 disposed in the pinion carrier 222 opposite the first side gear 226 for rotation relative to the pinion carrier 222 about the first axis A1. The second side gear 230 is configured to be coupled (directly or indirectly through an intermediate component) to the other of the half shafts 218. The illustrated differential assembly 82 further includes a plurality of pinion gears 234 coupled to the pinion carrier 222 for rotation about a second axis A2 transverse to the first axis A1. For example, the plurality of pinion gears 234 may be coupled to the pinion carrier 222 via a pinion shaft 238 coupled to the pinion carrier 222 for rotation with the pinion carrier 222 about the first axis A1. Where included, the pinion shaft 238 extends along the second axis A2 and the plurality of pinion gears 234 are coupled to the pinion shaft 238 for rotation about the second axis A2. Each pinion gear 234 is meshed with the first side gear 226 and the second side gear 230. The plurality of pinion gears 234 permit the first side gear 226 and the second side gear 230 to rotate at different angular speeds relative to one another. Thus, for example, when the vehicle including the electric drive unit 50 turns or one drive wheel experiences a traction difference, the plurality of pinion gears 234 rotate about the second axis A2 to accommodate the relative speed differential between the side gears 226, 230 while maintaining torque transfer to at least one of the side gears 226, 230.

As also described above, the electric drive unit 50 includes a reduction gearset 86 for transmit torque between the electric machine 78 and the differential assembly 82. The configuration of the reduction gearset 86 is not limited for the purposes of this disclosure. Exemplary configurations of the reduction gearset 86 include planetary gearsets, layshaft gearsets, countershaft gearsets, parallel axis gearsets, compound gearsets, and multi-stage reduction gearsets. Where the reduction gearset 86 includes planetary gearsets, the reduction gearset 86 may include single-stage planetary gearsets or multi-stage planetary gearsets. As best shown in FIGS. 4 and 10-11, in the illustrated configuration, the reduction gearset 86 includes a first planetary gearset 242 and a second planetary gearset 246 arranged in series to constitute a two-stage planetary reduction gearset.

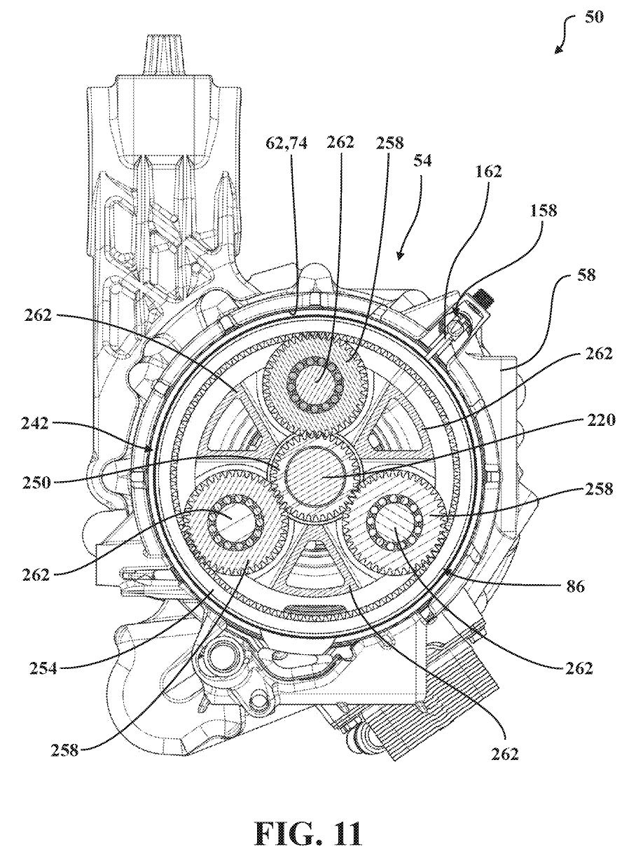

As best shown in FIG. 11, the first planetary gearset 242 includes a first sun gear 250. The first sun gear 250 is coupled to the electric machine 78 to transfer torque between the electric machine 78 and the reduction gearset 86. More specifically, the first sun gear 250 may be coupled to the second rotor shaft portion 214B for rotation with the rotor 190 about the first axis A1. In the illustrated configuration, the first sun gear 250 is integral with the second rotor shaft portion 214B, but configurations where the first sun gear 250 is a separate component coupled to the rotor shaft 214 are contemplated. The first planetary gearset 242 of the illustrated reduction gearset 86 also includes a first ring gear 254 fixed to the main housing body 58. The first ring gear 254 is typically fixed to the main housing body 58 such that the first ring gear 254 is rotationally constrained relative to the main housing body 58. For example, the first ring gear 254 may be welded or otherwise fastened to the main housing body 58. The first planetary gearset 242 of the illustrated reduction gearset 86 further includes a plurality of first planet gears 258 disposed between and meshed with the first sun gear 250 and the first ring gear 254. Accordingly, the plurality of first planet gears 258 are configured to orbit about the first axis A1 in response to rotation of the first sun gear 250. The first planetary gearset 242 of the illustrated reduction gearset 86 additionally includes a first planet carrier 262 coupled to the plurality of first planet gears 258. More specifically, the first planet carrier 262 maintains an angular spacing about the first axis A1 between each planet gear 258 of the plurality of first planet gears 258. Accordingly, the first planet carrier 262 rotates about the first axis A1 as the plurality of first planet gears 258 orbit about the first axis A1. In other words, during operation of the first planetary gearset 242, rotation of the first sun gear 250 at a first input speed causes the first planet gears 258 to orbit about the first axis A1, thereby driving rotation of the first planet carrier 262 about the first axis A1 at a first output speed less than the first input speed. The ratio of the first input speed to the first output speed defines the gear ratio of the first planetary gearset 242 of the illustrated reduction gearset 86.

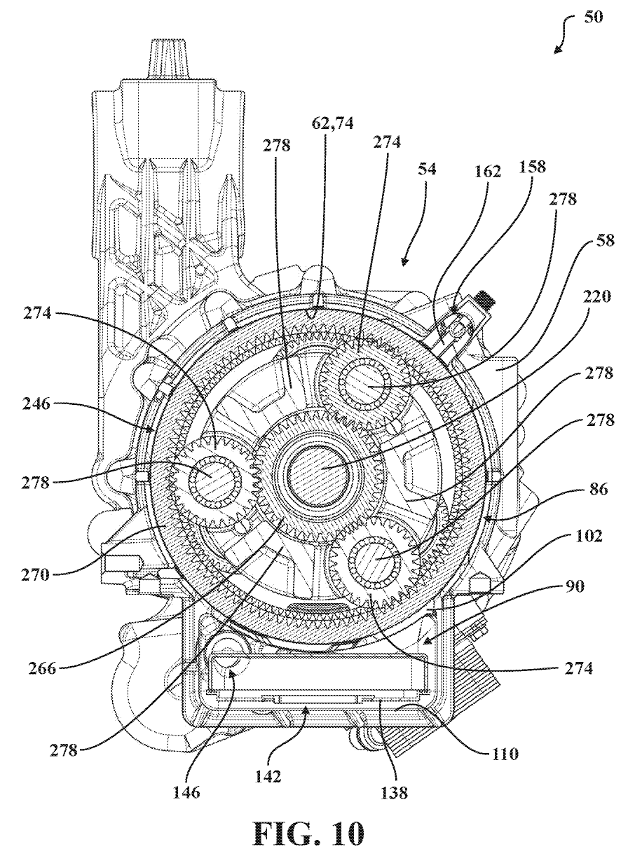

As best shown in FIG. 10, the second planetary gearset 246 of the illustrated reduction gearset 86 includes a second sun gear 266 coupled to the first planet carrier 262 for rotation with the first planet carrier 262 about the first axis A1. Stated differently, the output of the first planetary gearset 242 (i.e., the first planet carrier 262) is coupled to the input of the second planetary gearset 246 (i.e., the second sun gear 266) such that the first planetary gearset 242 and the second planetary gearset 246 are arranged in series. The second planetary gearset 246 of the illustrated reduction gearset 86 also includes a second ring gear 270 fixed to the main housing body 58. The second ring gear 270 is typically fixed to the main housing body 58 such that the second ring gear 270 is rotationally constrained relative to the main housing body 58. For example, the second ring gear 270 may be welded or otherwise fastened to the main housing body 58. The second planetary gearset 246 of the illustrated reduction gearset 86 further includes a plurality of second planet gears 274 disposed between and meshed with the second sun gear 266 and the second ring gear 270. Accordingly, the plurality of second planet gears 274 are configured to orbit about the first axis A1 in response to rotation of the second sun gear 266. The second planetary gearset 246 of the illustrated reduction gearset 86 additionally includes a second planet carrier 278 coupled to the second planet gears 274 and the differential assembly 82 to transmit torque between the reduction gearset 86 and the differential assembly 82. More specifically, the second planet carrier 278 maintains an angular spacing about the first axis A1 between each planet gear 274 of the plurality of second planet gears 274. Accordingly, the second planet carrier 278 rotates about the first axis A1 as the plurality of second planet gears 274 orbit about the first axis A1. In other words, during operation of the second planetary gearset 246, rotation of the second sun gear 266 at a second input speed causes the second planet gears 274 to orbit about the first axis A1, thereby driving rotation of the second planet carrier 278 about the first axis A1 at a second output speed less than the second input speed. The ratio of the second input speed to the second output speed defines the gear ratio of the second planetary gearset 246 of the illustrated reduction gearset 86. Cumulatively, the product of the gear ratio of the first planetary gearset 242 and the gear ratio of the second planetary gearset 246 defines the overall gear ratio of the reduction gearset 86. The reduction gearset 86 may have a gear ratio of 2:1 or greater, 5:1 or greater, 10:1 or greater, 15:1 or greater, 20:1 or greater, etc.

In the illustrated configuration, to transmit torque between the reduction gearset 86 and the differential assembly 82, the second planet carrier 278 of the second planetary gearset 246 is coupled to the pinion carrier 222 of the differential assembly 82 for rotation with the pinion carrier 222 about the first axis A1. Accordingly, the torque transmission path through the electric drive unit 50 extends from the electric machine 78 to the reduction gearset 86 and to the differential assembly 82. In other words, rotation generated by the rotor 190 is carried by the rotor shaft 214 to the first sun gear 250, transferred through the first planetary gearset 242 to the first planet carrier 262, passed from the first planet carrier 262 to the second sun gear 266, and then transferred through the second planetary gearset 246 to the second planet carrier 278 and ultimately to the pinion carrier 222 of the differential assembly 82. The differential assembly 82 then distributes the torque between the first side gear 226 and the second side gear 230. It should be appreciated that the configurations of the electric machine 78, the reduction gearset 86, and the differential assembly 82 illustrated and described herein are intended to serve as illustrative examples of suitable configurations of the electric machine 78, the reduction gearset 86, and the differential assembly 82 and the resulting torque transmission path therethrough, and that other configurations are contemplated.

Several embodiments have been described in the foregoing description. However, the embodiments described herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular. It will be further appreciated that the terms “include,” “includes,” and “including” have the same meaning as the terms “comprise,” “comprises,” and “comprising.”

What is claimed is:

1. An electric drive unit comprising:
a housing assembly comprising a main housing body extending along a first axis between a first end and a second end spaced from said first end in a first direction along said first axis, wherein said main housing body defines a housing interior about said first axis and includes a divider wall that subdivides said housing interior into a first chamber extending along said first axis and delimited by said divider wall in said first direction, and a second chamber extending along said first axis delimited by said divider wall in a second direction opposite said first direction;
an electric machine disposed in said first chamber;
a differential assembly disposed in said second chamber; and
a reduction gearset coupled to said electric machine and said differential assembly for transmitting torque between said electric machine and said differential assembly;
wherein said main housing body further defines:
a fluid sump spaced radially outward relative to said first axis from said first chamber and said second chamber;
a first drain path extending between said first chamber and said fluid sump to arrange said first chamber in fluid communication with said fluid sump for returning fluid from said first chamber to said fluid sump; and
a second drain path extending between said second chamber and said fluid sump to arrange said second chamber in fluid communication with said fluid sump for returning the fluid from said second chamber to said fluid sump.

2. The electric drive unit according to claim 1, wherein said main housing body further includes an upper sump wall extending axially relative to said first axis separating said fluid sump from said first chamber and said second chamber.

3. The electric drive unit according to claim 2, wherein said first drain path extends through said upper sump wall between said first chamber and said fluid sump; and
wherein said second drain path extends through said upper sump wall between said second chamber and said fluid sump.

4. The electric drive unit according to claim 1, wherein said main housing body includes a radial extension and a lower sump wall extending axially relative to the radial extension to define said fluid sump.

5. The electric drive unit according to claim 1 further comprising a fluid pump coupled to said main housing body and configured to direct the fluid from said fluid sump to said housing interior, wherein said fluid pump defines a pump inlet in fluid communication with said fluid sump and a pump outlet in fluid communication with said housing interior.

6. The electric drive unit according to claim 5, wherein said main housing body defines a fluid passage for arranging said fluid sump in fluid communication with said fluid pump, said fluid passage extending between:
a fluid passage inlet radially spaced from said first axis at a first distance and in fluid communication with said fluid sump; and
a fluid passage outlet radially spaced from said first axis at a second distance greater than said first distance and in fluid communication with said pump inlet of said fluid pump.

7. The electric drive unit according to claim 6 further comprising an integrated fluid filter housing disposed in said fluid sump and configured to receive a filter for filtering contaminants as the fluid travels from said fluid sump to said pump inlet;
wherein said integrated fluid filter housing has a filter housing inlet in fluid communication with said fluid sump and a filter housing outlet in fluid communication with said fluid passage inlet of said fluid passage.

8. The electric drive unit according to claim 7, wherein said housing assembly further comprises a second end cover coupled to said second end of said main housing body to delimit said second chamber and said fluid sump in said first direction.

9. The electric drive unit according to claim 8, wherein said second end cover is removably coupled to said main housing body so said integrated fluid filter housing disposed in said fluid sump is accessible from said second end.

10. The electric drive unit according to claim 5, wherein said main housing body further defines:
a main supply channel spaced radially from said first axis and extending parallel to said first axis, wherein said main supply channel is in fluid communication with said pump outlet for receiving the fluid from said fluid pump for distribution to said housing interior; and
a plurality of distribution channels in fluid communication with at least one of said first chamber and said second chamber for directing the fluid from said main supply channel into said at least one of said first chamber and said second chamber.

11. The electric drive unit according to claim 10, wherein said main housing body further defines a fluid feeding path in fluid communication with said pump outlet and said main supply channel for directing the fluid from said pump outlet to said main supply channel.

12. The electric drive unit according to claim 11 further comprising a heat exchanger disposed in fluid communication along said fluid feeding path.

13. The electric drive unit according to claim 1, wherein said housing assembly further comprises a first end cover coupled to said first end of said main housing body to delimit said first chamber in said second direction.

14. The electric drive unit according to claim 1, wherein said housing assembly further comprises a second end cover coupled to said second end of said main housing body to delimit said second chamber in said first direction.

15. The electric drive unit according to claim 14, wherein said second end cover further delimits said fluid sump in said first direction.

16. The electric drive unit according to claim 1, wherein said electric machine comprises:
a stator coupled to said main housing body and disposed annularly about said first axis, said stator defining a stator bore; and
a rotor disposed in said stator bore for rotation relative to said stator about said first axis in response to energization of said stator.

17. The electric drive unit according to claim 16, wherein said reduction gearset is disposed in said second chamber;
wherein said divider wall defines a central void extending along said first axis;
wherein said rotor comprises a rotor body disposed in said stator bore and a rotor shaft extending along said first axis between:
a first rotor shaft portion coupled to said rotor body such that said rotor shaft rotates with said rotor body about said first axis in response to energization of said stator; and
a second rotor shaft portion extending from said first rotor shaft portion in said first direction through said central void of said divider wall, said second rotor shaft portion coupled to said reduction gearset to transmit torque between said electric machine and said reduction gearset.

18. The electric drive unit according to claim 1, wherein said differential assembly comprises:
a pinion carrier supported for rotation about said first axis;
a first side gear disposed in said pinion carrier for rotation relative to said pinion carrier about said first axis;
a second side gear disposed in said pinion carrier opposite said first side gear for rotation relative to said pinion carrier about said first axis; and
a plurality of pinion gears coupled to said pinion carrier for rotation about a second axis transverse to said first axis, each of said plurality of pinion gears meshed with said first side gear and said second side gear to transfer torque from said pinion carrier to said first side gear and said second side gear.

19. The electric drive unit according to claim 18, wherein said electric machine includes a rotor defining a central bore extending along said first axis; and
wherein said electric drive unit further comprises a link shaft coupled to said first side gear and extending from said first side gear in said second direction along said first axis through said central bore of said rotor.

20. The electric drive unit according to claim 1, wherein said reduction gearset comprises:
a first planetary gearset comprising:
a first sun gear coupled to said electric machine to transmit torque between said reduction gearset and said electric machine;
a first ring gear fixed to said main housing body;
a plurality of first planet gears disposed between and meshed with said first sun gear and said first ring gear such that said plurality of first planet gears orbit about said first axis in response to rotation of said first sun gear; and
a first planet carrier coupled to said plurality of first planet gears such that said first planet carrier rotates about said first axis in response to rotation of said first sun gear; and
a second planetary gearset comprising:
a second sun gear coupled to said first planet carrier for rotation with said first planet carrier about said first axis;
a second ring gear fixed to said main housing body;
a plurality of second planet gears disposed between and meshed with said second sun gear and said second ring gear such that said plurality of second planet gears orbit about said first axis in response to rotation of said second sun gear; and
a second planet carrier coupled to said plurality of second planet gears and said differential assembly to transmit torque between said reduction gearset and said differential assembly.
